(19) United States
(12) Patent Application Publication
(10) Pub. No.: US 2023/0224345 A1
(43) Pub. Date: Jul. 13, 2023

(54) ELECTRONIC CONFERENCING SYSTEM

(71) Applicant: TOSHIBA TEC KABUSHIKI KAISHA, Tokyo (JP)

(72) Inventors: Naoki SEKINE, Mishima Shizuoka (JP); Shogo WATADA, Numazu Shizuoka (JP)

(21) Appl. No.: 17/982,461

(22) Filed: Nov. 7, 2022

(30) Foreign Application Priority Data
Jan. 12, 2022 (JP) 2022-003008

(51) Int. Cl. H04L 65/403; G10L 15/26

(52) U.S. Cl. CPC H04L 65/403; G10L 15/26

(57) ABSTRACT

An electronic conferencing system includes a conferencing server that stores first data including one or more first keywords, and a plurality of user terminals connectable to each other via the server for an electronic conference. Each user terminal includes a microphone, and a processor configured to: acquire voice data corresponding to a speech input by a user via the microphone, convert the voice data to text data, and determine whether to output the voice data to another user terminal based on whether a word included in the text data matches one of the first keywords.

### CROSS-REFERENCE TO RELATED APPLICATION(S)

This application is based upon and claims the benefit of priority from Japanese Patent Application No. 2022-003008, filed Jan. 12, 2022, the entire contents of which are incorporated herein by reference.

### FIELD

Embodiments described herein relate generally to an electronic conferencing system, a method for managing an electronic conference, and a non-transitory computer readable medium storing a program for managing an electronic conference.

### BACKGROUND

Electronic conferencing systems such as video conferencing systems and web conferencing systems using a plurality of information processing apparatuses connected via a network are widely used. In such electronic conference systems, it is usually necessary for the user to manually set the microphone on mute to prevent any voice or sound from being heard by the other users. Thus, it sometimes happens that the user forgets to mute the microphone and his or her utterances not to be shared such as private or confidential conversations are heard by the other users.

### SUMMARY OF THE INVENTION

Embodiments provide a technology capable of preventing specific words from being transmitted and realizing a secure and smooth electronic conference.

In one embodiment, an electronic conferencing system includes a conferencing server that stores first data including one or more first keywords, and a plurality of user terminals connectable to each other via the server for an electronic conference. Each user terminal includes a microphone and a processor. The processor is configured to: acquire voice data corresponding to a speech input by a user via the microphone, convert the voice data to text data, and determine whether to output the voice data to another user terminal based on whether a word included in the text data matches one of the first keywords.

### BRIEF DESCRIPTION OF THE DRAWINGS

FIG. 1 is a diagram of a web conferencing system according to an embodiment.

FIG. 2 is a diagram of a data structure of a keyword database stored in a server according to an embodiment.

FIG. 3 is a flowchart of a voice output control process performed by a first information processing apparatus according to an embodiment.

FIG. 4 is a diagram schematically illustrating an example of a vector space of a related word group according to an embodiment.

FIG. 5 is a diagram schematically illustrating another example of the vector space of the related word group.

FIG. 6 is a flowchart of a related word group database generation process performed by the first information processing apparatus.

FIG. 7 is a flowchart of another example of the voice output control process performed by the first information processing apparatus.

### DETAILED DESCRIPTION

Hereinafter, exemplary embodiments will be described with reference to the drawings. In the drawings, the same components or elements are denoted by the same reference numerals, and the same descriptions therefor will be repeated.

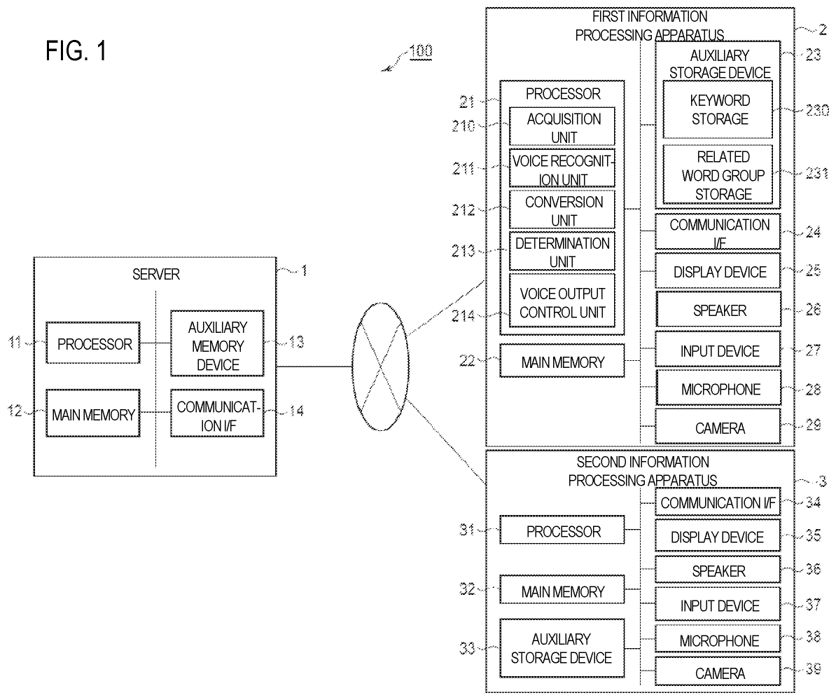

FIG. 1 is a diagram illustrating a web conferencing system 100 according to an embodiment.

The web conferencing system 100 includes a server 1, a first information processing apparatus 2, and a second information processing apparatus 3. The server 1, the first information processing apparatus 2, and the second information processing apparatus 3 are communicably connected to each other via a network. For example, the network may comprise one or more networks of various networks, such as the Internet, a mobile communication network, and a LAN (Local Area Network). The one or more networks may include a wireless network or may include a wired network. The web conferencing system 100 may refer to a system including at least two devices among the server 1, the first information processing apparatus 2, and the second information processing apparatus 3.

The server 1 is an electronic device that collects data and processes the collected data. The electronic device includes a computer. The server 1 is communicably connected to the first information processing apparatus 2 and the second information processing apparatus 3 via a network. The first information processing apparatus 2 and the second information processing apparatus 3 are used by different users at different locations, for example. The server 1 receives various data from the first information processing apparatus 2 and the second information processing apparatus 3, and outputs various data to the first information processing apparatus 2 and the second information processing apparatus 3. A configuration example of the server 1 will be described later.

The first information processing apparatus 2 is an electronic terminal capable of communicating with other electronic devices. The first information processing apparatus 2 is, for example, a device used by a participant of a web conference. For example, the first information processing apparatus 2 is a PC (Personal Computer), a smart phone, a tablet terminal, or the like. Hereinafter, a participant may be referred to as a user or a person. A configuration example of the first information processing apparatus 2 will be described later.

The second information processing apparatus 3 is an electronic terminal capable of communicating with other electronic devices. The second information processing apparatus 3 is, for example, a device used by a host or a participant of a web conference. For example, the second information processing apparatus 3 is a PC, a smart phone, a tablet terminal, or the like. The host may be referred to as the user or the person. A configuration example of the second information processing apparatus 3 will be described later.

In the following description, the term “information processing apparatus” may simply refer to either the first information processing apparatus 2 or the second information processing apparatus 3, or may collectively refer to the first information processing apparatus 2 and the second information processing apparatus 3.

A configuration example of the server 1 will be described.

The server 1 is an electronic device including a processor 11, a main memory 12, an auxiliary storage device 13, and a communication interface 14. Those components constituting the server 1 are connected to each other so as to be able to input and output signals. In FIG. 1, the interface is described as “I/F”.

For example, the processor 11 is a CPU (Central Processing Unit), but is not limited thereto. The processor 11 may be various circuits. The processor 11 loads a program stored in advance in the main memory 12 or the auxiliary storage device 13 onto the main memory 12. The processor 11 of the server 1 executes the program to perform the functions of the server 1 described later.

The main memory 12 includes a non-volatile memory area and a volatile memory area. The non-volatile memory area of the main memory 12 stores an operating system and/or programs. The volatile memory area of the main memory 12 is used as a work area in which data is rewritten by the processor 11. For example, the main memory 12 includes a ROM (Read Only Memory) as the non-volatile memory area. For example, the main memory 12 includes a RAM (Random Access Memory) as the volatile memory area.

The auxiliary storage device 13 is a EEPROM (Electric Erasable Programmable Read-Only Memory), an HDD (Hard Disc Drive), or an SSD (Solid State Drive). The auxiliary storage device 13 stores the above-described programs, data used by the processor 11 in performing various types of processing, and data generated by the processor 11.

The auxiliary storage device 13 stores information of users of the first information processing apparatus 2 and the second information processing apparatus 3 participating in a web conference provided by the web conference system 100. That information includes user identification information, identification information of each of the information processing apparatuses 2 and 3 used by the users, and the like. The user identification information is unique identification information assigned to each user in order to identify the user. The identification information of each information processing apparatus is unique identification information assigned to each information processing apparatus in order to individually identify the information processing apparatus. The identification information of each information processing apparatus includes an IP address or the like of the information processing apparatus.

The communication interface 14 is a network interface circuit for communicably connecting the server 1 to other electronic devices via a network according to a known communication protocol.

The hardware configuration of the server 1 is not limited to the above-described configuration. One or more of the above-described components of the server 1 may be omitted or modified, and one or more new components may be added thereto as appropriate.

A configuration example of the first information processing apparatus 2 will be described.

The first information processing apparatus 2 is an electronic apparatus including a processor 21, a main memory 22, an auxiliary storage device 23, a communication interface 24, a display device 25, a speaker 26, an input device 27, a microphone 28, and a camera 29. Those components constituting the first information processing apparatus 2 are connected to each other so as to be able to input and output signals.

The processor 21 has a hardware configuration similar to that of the processor 11 described above. The processor 21 executes various operations by executing programs stored in advance in the main memory 22 or the auxiliary storage device 23.

The main memory 22 has the same hardware configuration as that of the main memory 12 described above. That is, the main memory 22 stores an operating system and one or more programs to be executed by the processor 21.

The auxiliary storage device 23 has the same hardware configuration as that of the auxiliary storage device 13 described above. The auxiliary storage device 23 stores the above-described operating system and programs.

The auxiliary storage device 23 stores information of the user of the first information processing apparatus 2. That information includes user identification information, identification information of the first information processing apparatus 2, and the like. The user identification information is the unique identification information assigned to the user in order to identify the user. The identification information of the first information processing apparatus 2 is unique identification information assigned to the first information processing apparatus 2 in order to identify the first information processing apparatus 2. The identification information of the first information processing apparatus 2 includes an IP address or the like of the first information processing apparatus 2.

The auxiliary storage device 23 includes a keyword storage area 230. The keyword storage area 230 stores at least one keyword database (DB). The keyword DB stores one or more particular words. The particular words, for example, indicate words that are not desired to be transmitted to other participants. The particular words indicate, for example, negative words, inappropriate words, unfavorable words, words including sensitive matters, and the like. Hereinafter, the particular words are also referred to as the keywords. Additionally, the keyword DB may store certain general words that do not want to be transmitted to other participants regardless of the type of conference, for example, “long speech”, “hungry,” “sleepy,” “bored,” etc.

The keyword DB may be managed in association with a type of conference. In such a case, the particular words may include a word that is not desired to be transmitted to another participant set based on the type of the conference, a word that is not related to the type of the conference, and the like. The type of conference includes, for example, an industry, a participant, a subject, a topic, a theme, and the like. When the type of conference is “industry”, the keyword DB may be associated with, for example, “food and beverage”, “construction”, and the like. When the type of conference is “participant”, the keyword DB may be associated with, for example, “board meeting”, “internal meeting”, “external meeting”, etc. When the type of the conference is “agenda”, the keyword DB may be associated with, for example, “planning conference”, “sales report”, or the like. Specifically, when the type of the conference is “construction”, the corresponding keyword DB includes keywords that are not related to the content of the conference such as “hungry” and “menu”. The keyword DB may be associated with at least one type of conference. The keyword DB may be set in advance or may be appropriately set or updated by an administrator or the like. In the following description, “word” may be read as a word, phrase, clause, or sentence.

The auxiliary storage device 23 includes a related word group storage area 231. The related word group storage area 231 stores at least one related word group data base (DB). The related word group DB stores a group of related words. The related words include, for example, a word frequently used in a conference, a word related to the subject of a conference, or the like. The related word group DB may be set for each type of conference.

The related word group DB stores a group of related words associated with a word vector. The word vector is also referred to as a word distributed representation. The word vector is a numeric representation of related words, for example, using known techniques such as Bag of Words, Word2Vec. The words included in the same related word group have short distances therebetween. A word having a short distance to another word indicates that the similarity of the two words is high. Thus, the distance between words is also referred to as the similarity between words. The distance or similarity of the words included in the related word group may be any value. The related word group DB may be set in advance or may be appropriately set or updated by an administrator or the like. The related words DB may be generated in an ongoing conference. In such a case, the related word group DB may be generated by a conversion unit 212 described later. The conversion unit 212 may store, in the related word group DB, only a word that is close to the related word group. The related word group DB may include a plurality of related word groups.

The communication interface 24 is a network interface circuit for communicably connecting the first information processing apparatus 2 to other devices via a network in accordance with a known communication protocol.

The display device 25 is capable of displaying various screens under the control of the processor 21. For example, the display device 25 may be an LCD (liquid crystal display) or an EL (Electroluminescence) display.

The speaker 26 is capable of outputting voice under the control of the processor 21.

The input device 27 is capable of inputting data and instructions to the first information processing apparatus 2. For example, the input device 27 includes a keyboard, a touch panel, or the like.

The microphone 28 is capable of inputting voice to the first information processing apparatus 2. For example, the microphone 28 may be a built-in microphone or an external microphone.

The camera 29 is capable of capturing an image of an object, e.g., the user of the first information processing apparatus 2, which is present within a photographing range. For example, the camera 29 may be a built-in camera or an external camera.

The hardware configuration of the first information processing apparatus 2 is not limited to the above-described configuration. One or more of the above-described components of the first information processing apparatus 2 may be omitted or modified, and one or more new components may be added thereto as appropriate.

The functions performed by the above-described processor 21 will be described below.

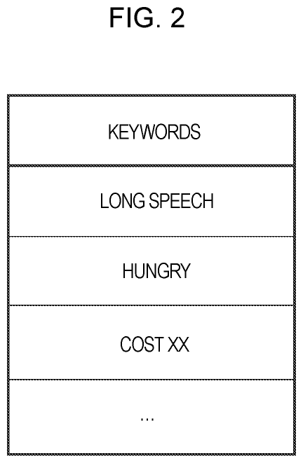

The processor 21 executes one or more programs to function as an acquisition unit 210, a voice recognition unit 211, a conversion unit 212, a determination unit 213, and a voice output control unit 214 as shown in FIG. 2.

The acquisition unit 210 acquires voice data corresponding to an utterance by the user of the first information processing apparatus 2 based on an input via the microphone 28. The acquisition unit 210 also acquires voice data corresponding to an utterance that is output via the speaker 26. The voice data output via the speaker 26 corresponds to voice data corresponding to an utterance by the user of the second information processing apparatus 3 acquired from the second information processing apparatus 3 via the communication interface 24. In the following description, “acquisition” may be read as “reception”.

The voice recognition unit 211 performs voice recognition based on the voice data acquired by the acquisition unit 210. Voice recognition includes, for example, converting voice data into text data, segmenting the text data, and extracting words from the text data using known techniques. The voice recognition unit 211 may store the recognition result in the auxiliary storage device 23. The recognition result indicates, for example, text data based on voice data.

The conversion unit 212 vectorizes the recognition result by the voice recognition unit 211. Vectorization includes, for example, quantifying the text data based on its characteristics using known techniques. The characteristics of the text data include the meaning, the number of appearances, and the importance of the segmented word, for example. The vectorized words and the like are mapped to coordinates on a multi-dimensional space. The conversion unit 212 may store the conversion result in the auxiliary storage device 23. The conversion result indicates, for example, the vector of each word included in the recognition result. The conversion unit 212 may update the related word group DB each time the conversion is acquired in real time.

The determination unit 213 determines whether the recognition result by the voice recognition unit 211 satisfies a predetermined condition. In one example, the predetermined condition is that the recognition result includes a keyword. In another example, the predetermined condition is whether the distance between the conversion result obtained by the conversion unit 212 and a particular word group is equal to or greater than a threshold value. The particular word group is, for example, at least one related word group included in the related word group DB.

The voice output control unit 214 controls the output of the voice data to the second information processing apparatus 3 via the network based on the determination result by the determination unit 213. The voice output control unit 214 stops the output of the voice data via the network on the basis that the determination unit 213 determines that the recognition result by the voice recognition unit 211 satisfies a predetermined condition. The voice output control unit 214 may stop outputting only the voice data corresponding to the recognition result satisfying the predetermined condition. For example, when the determination unit 213 determines that the recognition result “long speech” satisfies the predetermined condition, the voice output control unit 214 may stop outputting the voice data corresponding to “long speech”.

The voice output control unit 214 may disable the microphone 28 after the determination by the determination unit 213 that the recognition result satisfies the predetermined condition. Disabling the microphone 28 includes muting the microphone 28. For example, the voice output control unit 214 may mute the microphone 28 when the determination unit 213 determines that the recognition result “long speech” satisfies the predetermined condition. The voice output control unit 214 outputs the voice data via the network based on the determination by the determination unit 213 that the recognition result by the voice recognition unit 211 does not satisfy the predetermined condition.

A configuration example of the second information processing apparatus 3 will be described.

The second information processing apparatus 3 is an electronic device including a processor 31, a main memory 32, an auxiliary storage device 33, a communication interface 34, a display device 35, a speaker 36, an input device 37, a microphone 38, and a camera 39. Those components constituting the second information processing apparatus 3 are connected to each other so as to be able to input and output signals.

The processor 31 has a hardware configuration similar to that of the processor 11 described above. The processor 31 executes programs stored in advance in the main memory 32 or the auxiliary storage device 33. Similarly to the processor 21, the processor 31 functions as the acquisition unit 210, the voice recognition unit 211, the conversion unit 212, the determination unit 213, and the voice output control unit 214.

The main memory 32 has the same hardware configuration as that of the main memory 12 described above. That is, the main memory 32 stores an operating system and one or more programs to be executed by the processor 31.

The auxiliary storage device 33 has the same hardware configuration as the auxiliary storage device 13 described above. The auxiliary storage device 33 stores the above-described operating system and programs.

The auxiliary storage device 33 stores information of the user of the second information processing apparatus 3. That information includes user identification information, identification information of the second information processing apparatus 3, and the like. The user identification information is unique identification information assigned to the user in order to identify the user. The identification information of the second information processing apparatus 3 is unique identification information assigned to the second information processing apparatus 3 in order to identify the second information processing apparatus 3. The identification information of the second information processing apparatus 3 includes an IP address or the like of the second information processing apparatus 3.

Similarly to the auxiliary storage device 23, the auxiliary storage device 33 includes a keyword storage area 230 and a related word group storage area 231.

The communication interface 34 is a network interface circuit for communicably connecting the second information processing apparatus 3 to other devices via a network in accordance with a known communication protocol.

The display device 35 is capable of displaying various screens under the control of the processor 31. For example, the display device 35 is an LCD, an EL display, or the like.

The speaker 36 is a device capable of outputting voice under the control of the processor 31.

The input device 37 is capable of inputting data and instructions to the second information processing apparatus 3. For example, the input device 37 includes a keyboard, a touch panel, or the like.

The microphone 38 is capable of inputting voice to the second information processing apparatus 3. For example, the microphone 38 may be a built-in microphone or an external microphone.

The camera 39 is capable of capturing an image of an object, e.g., the user of the second information processing apparatus 3, which is present within a photographing range. For example, the camera 39 may be a built-in camera or an external camera.

The hardware configuration of the second information processing apparatus 3 is not limited to the above-described configuration. One or more of the above-described components of the second information processing apparatus 3 may be omitted or modified, and one or more new components may be added thereto as appropriate.

A configuration example of the keyword DB will be described.

FIG. 2 is a diagram illustrating a data structure of the keyword DB stored in the server 1 according to an embodiment.

The keyword DB stores at least one particular word. FIG. 2 shows the keyword DB associated with the type of conference “external conference”. The keyword DB illustrated in FIG. 2 includes keywords that are not desired to be transmitted to other participants, keywords that are not desired to be transmitted to outside participants, and the like. For example, the keywords include “long speech” and “hungry,” which are not to be transmitted to other participants, and “XX cost,” which is not to be transmitted to outside participants. The server 1 appropriately updates the keyword DB.

An example of the voice output control process performed by the first information processing apparatus 2 will be described.

In the following description of the process performed by the server 1, the server 1 may be read as the processor 11. Similarly, in the description of the process performed by the first information processing apparatus 2, the first information processing apparatus 2 may be read as the processor 21.

In the following process, the users of the first information processing apparatus 2 and the second information processing apparatus 3 participate in a web conference. The users of the first information processing apparatus 2 and the second information processing apparatus 3 log in to the web conference, and both the first information processing apparatus 2 and the second information processing apparatus 3 transmit voice data to each other.

Note that the process described below is merely an example, and each step may be changed. Further, one or more of the steps described below can be omitted, replaced, and added as appropriate.

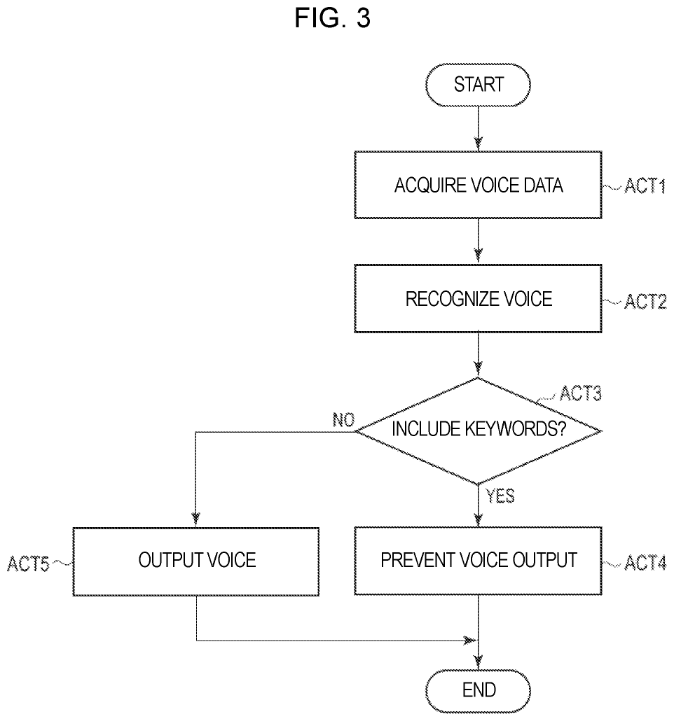

FIG. 3 is a flowchart of the voice output control process performed by the first information processing apparatus 2 according to an embodiment.

First, the user of the first information processing apparatus 2 selects a keyword DB to be used in a web conference. In the following process, it is assumed that the user of the first information processing apparatus 2 participates in, for example, an external conference by connecting, via the server 1 hosting the conference, the first information processing apparatus 2 to the second information processing apparatus 3 operated by an outside participant, and uses the keyword DB illustrated in FIG. 2. In this example, the first information processing apparatus 2 performs the voice output control process based on voice data of utterances by the user of the first information processing apparatus 2.

The acquiring unit 210 acquires voice data corresponding to an utterance by the user of the first information processing apparatus 2 based on an input via the microphone 28 (ACT1).

The voice recognition unit 211 performs voice recognition on the voice data acquired by the acquisition unit 210 (ACT2). In ACT2, for example, the voice recognition unit 211 converts the voice data into text data. The voice recognition unit 211 acquires the text data as a recognition result. The voice recognition unit 211 may perform segmentation using a word or the like as a minimum unit on the text data. In this case, the voice recognition unit 211 may acquire the segmented words or the like as a recognition result. The voice recognition unit 211 may store the recognition result in the auxiliary storage device 23.

The determination unit 213 determines whether the recognition result performed by the voice recognition unit 211 satisfies a predetermined condition (ACT3). In ACT3, for example, the determination unit 213 acquires the recognition result. The determination unit 213 determines whether a keyword is included in the recognition result based on the keyword DB.

When the determination unit 213 determines that a keyword is included in the recognition result (ACT3:YES), the process transitions from ACT3 to ACT4. When the determination unit 213 determines that no keyword is included in the recognition result (ACT3:NO), the process transitions from ACT3 to ACT5. The voice output control unit 214 controls the output of the voice data to the second information processing apparatus 3 via the network based on the determination result by the determination unit 213.

The voice output control unit 214 controls the output of the voice data via the network based on the determination by the determination unit 213 that the recognition result satisfies the predetermined condition (ACT4). In ACT4, for example, the voice output control unit 214 prevents the output of the voice data to the second information processing apparatus 3 via the network based on the determination by the determination unit 213 that a keyword is included in the recognition result. In this case, the voice output control unit 214 does not output only the voice data corresponding to the word or the like matching the keyword in the recognition result. For example, a case where “long speech” is included in the recognition result will be described. Since a word or the like matching the keyword “long speech” included in the keyword DB is included in the recognition result, the voice data corresponding to “long speech” is not output to the second information processing apparatus 3. The voice output control unit 214 may mute the microphone 28 in response to the determination that the recognition result includes the keyword.

The voice output control unit 214 outputs the voice data via the network based on the determination by the determination unit 213 that the recognition result does not satisfy the predetermined condition (ACT5). In ACT5, for example, the voice output control unit 214 outputs the voice data to the second information processing apparatus 3 via the network based on the determination by the determination unit 213 that a keyword is not included in the recognition result.

The vector space of the related word group will be described.

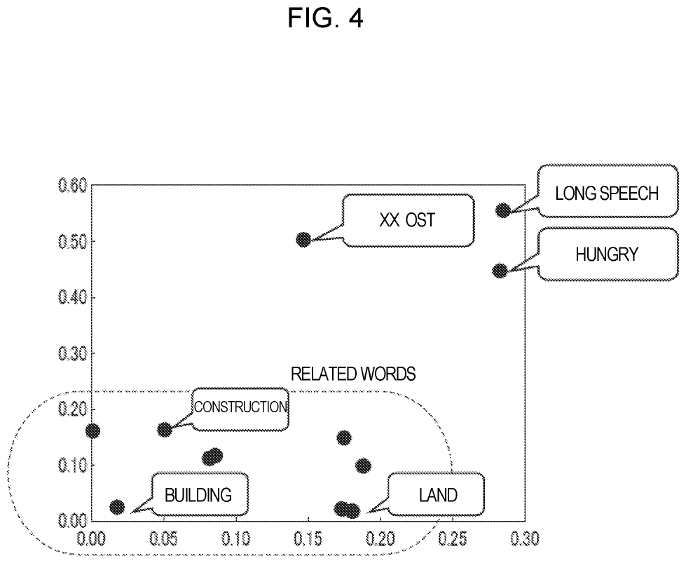

FIG. 4 is a diagram schematically illustrating an example of a vector space of a related word group according to an embodiment.

FIG. 4 illustrates a vector space of related words included in the related word group DB associated with the conference type “construction”. The related words include frequently used words in conferences related to the “construction”, words related to the contents of the conference, and the like. For example, the related word group includes “construction”, “building”, “land”, and the like. The words of the related word group are arranged in a multi-dimensional vector space as shown in FIG. 4. Those words have a high degree of similarity, and therefore are arranged close to each other in the vector space. In FIG. 4, the related word group indicates a set of similar words surrounded by a dashed line. For example, the words not included in the related word group or the like “long speech”, “hungry”, and “XX cost” are arranged at positions apart from the set of the related word group.

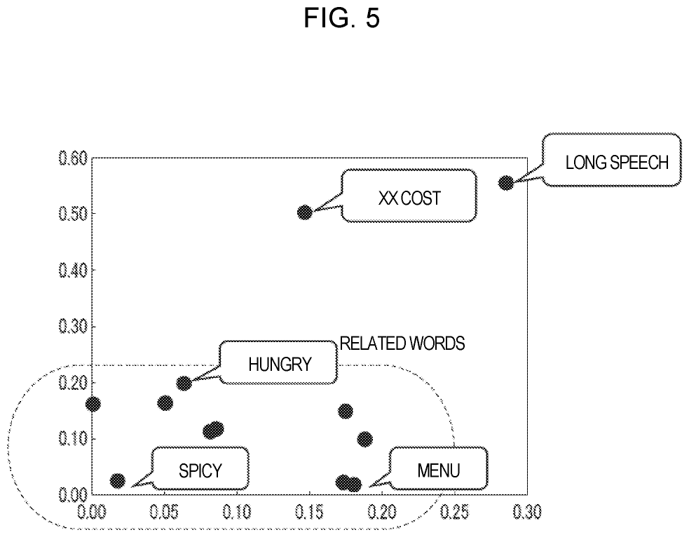

FIG. 5 is a diagram schematically illustrating another example of the vector space of the related word group according to an embodiment.

FIG. 5 illustrates a vector space of related words included in the related word group DB associated with the conference type “food and beverage”. The related word group includes frequently used words in conferences related to the “food and beverage”, words related to the contents of such conferences, and the like. For example, the related word group includes “spicy”, “menu”, “hungry”, and the like. In FIG. 5, the related word group are surrounded by a dashed line. For example, the words not included in the related word group, e.g., “long speech” and “XX cost”, are arranged at a position away from the set of the related word group. The related word group DB associated with the conference type “food and beverage” is different from the related word group DB associated with the conference type “construction” illustrated in FIG. 4, in that the related word group includes “hungry”. Therefore, in FIG. 4, the word “hungry” is arranged at a position away from the set of related words, whereas in FIG. 5, the word “hungry” is arranged so as to be included in the set of related words.

Although FIG. 4 and FIG. 5 show a two-dimensional space, the related word group may be arranged in any multi-dimensional space.

A procedure of the related word group database generation process by the first information processing apparatus 2 will be described.

Note that, in the following description of the process performed by the server 1, the server 1 may be read as the processor 11. Similarly, in the description of the process performed by the first information processing apparatus 2, the first information processing apparatus 2 may be read as the processor 21.

In the following process, the users of the first information processing apparatus 2 and the second information processing apparatus 3 participate in a web conference. The users of the first information processing apparatus 2 and the second information processing apparatus 3 log in to the web conference, and both of the first information processing apparatus 2 and the second information processing apparatus 3 transmit voice data. It is assumed that the first information processing apparatus 2 acquires the voice data corresponding to the utterance by the user of the second information processing apparatus 3 outputted from the speaker 26, and generates the related word group DB. The voice data corresponding to the utterance by the user of the second information processing apparatus 3 is obtained by executing the voice output control process by the second information processing apparatus 3 similar to the voice output control process by the first information processing apparatus 2 described later. Therefore, it is assumed that the voice data corresponding to the utterance by the user of the second information processing apparatus 3 does not include the voice data including a word having a word vector at a position away from the set of related word groups.

The process described below is merely an example, and each step may be changed. Further, one or more of the steps described below can be omitted, replaced, and added as appropriate.

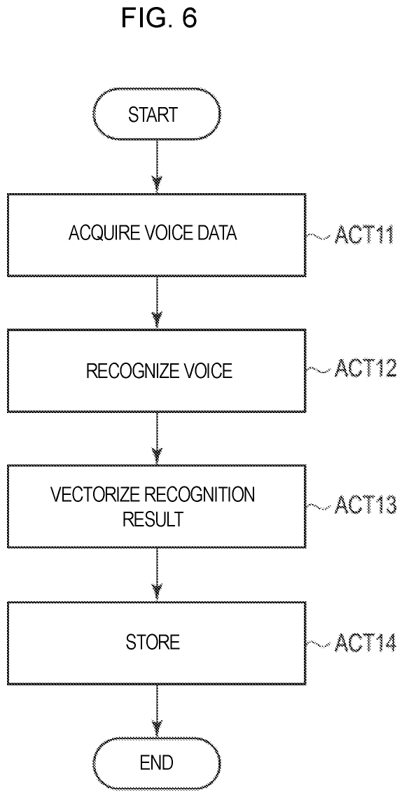

FIG. 6 is a flowchart of the related word group database generation process performed by the first information processing apparatus 2 according to an embodiment.

The acquisition unit 210 acquires voice data (ACT11). In ACT11, for example, the acquiring unit 210 acquires the voice data corresponding to the utterance by the second information processing apparatus 3 outputted via the speaker 26.

The voice recognition unit 211 performs voice recognition on the voice data acquired by the acquisition unit 210 (ACT12). In ACT12, for example, the voice recognition unit 211 performs voice recognition on the voice data in the same manner as in ACT2, and acquires the recognition result. The voice recognition unit 211 may store the recognition result in the auxiliary storage device 23.

The conversion unit 212 vectorizes the recognition result generated by the voice recognition unit 211 (ACT13). Specifically, in ACT13, the conversion unit 212 digitizes one or more words or the like included in the text data based on their characteristics using a known technique. The conversion unit 212 stores the vectorized or digitized words in a related word group DB stored in the auxiliary storage device 23 (ACT14). The conversion unit 212 may update the related word group DB in real time each time new voice data is acquired.

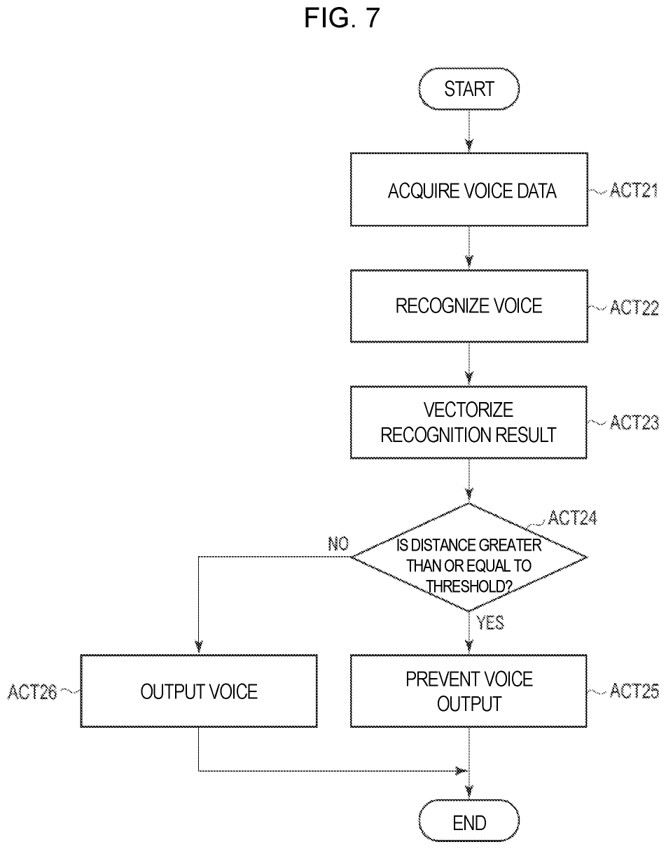

FIG. 7 is a flowchart of a voice output control process performed by the first information processing apparatus 2 according to an embodiment.

First, the user of the first information processing apparatus 2 selects a related word group DB to be used in a web conference. In the following process, it is assumed that the user of the first information processing apparatus 2 participates in, for example, a conference related to the “construction” and uses the related word group DB illustrated in FIG. 4. In this example, the first information processing apparatus 2 performs the voice output control process on voice data corresponding to the utterances by the user of the first information processing apparatus 2.

The acquiring unit 210 acquires the voice data corresponding to the utterance by the user of the first information processing apparatus 2 based on the input via the microphone 28 (ACT21).

The voice recognition unit 211 performs voice recognition on the voice data acquired by the acquisition unit 210 (ACT22). In ACT22, for example, the voice recognition unit 211 converts the voice data into text data in the same manner as in ACT2. The voice recognition unit 211 acquires text data as a recognition result. The voice recognition unit 211 may perform segmentation using a word or the like as a minimum unit on the text data. In this case, the voice recognition unit 211 may acquire segmented words as a recognition result. The voice recognition unit 211 may store the recognition result in the auxiliary storage device 23.

The conversion unit 212 vectorizes the recognition result obtained by the voice recognition unit 211 (ACT23). In ACT23, for example, similarly to ACT13, the conversion unit 212 digitizes the words included in the text data based on their characteristics using a known technique. The conversion unit 212 may store the conversion result in the auxiliary storage device 23.

The determination unit 213 determines whether the recognition result obtained by the voice recognition unit 211 satisfies a predetermined condition (ACT24). In ACT24, for example, the determination unit 213 acquires the conversion result obtained by the conversion unit 212. Based on the related word group DB, the determination unit 213 determines whether the distance between a word included in the conversion result and the related word group is equal to or greater than a threshold value. For example, the determination unit 213 uses the coordinates of an outer edge of the set of related word groups in the multi-dimensional vector space as the location of the related word group. The threshold value may be set in advance, or may be appropriately set by an administrator or the like. The threshold value may be set based on, for example, the type of the conference.

When the determination unit 213 determines that the distance between the word of the conversion result and the related word group is equal to or greater than the threshold value (ACT24:YES), the process transitions from ACT24 to ACT25. When the determination unit 213 determines that the distance between the word of the converted result and the related word group is not equal to or larger than the threshold value (ACT24:NO), the process transitions from ACT24 to ACT26. The voice output control unit 214 controls the output of the voice data to the second information processing apparatus 3 via the network based on the determination result by the determination unit 213. The voice output control unit 214 controls the output of the voice data via the network based on the determination by the determination unit 213 that the recognition result satisfies a predetermined condition (ACT25). In ACT25, for example, the voice output control unit 214 prevents the output of the voice data to the second information processing apparatus 3 via the network on the basis that the determination unit 213 determines that the distance between the word of the conversion result and the related word group is equal to or greater than the threshold value. In this case, the voice output control unit 214 prevents outputting only the voice data corresponding to the word of the conversion result in which the distance to the related word group is determined to be equal to or greater than the threshold value.

For example, a case where the recognition result by the voice recognition unit 211 includes “long speech” will be described. The determination unit 213 calculates a distance from the coordinates of the recognized and vectorized word “long speech” to the set of related word groups included in the related word group DB. When it is determined that the distance calculated by the determination unit 213 is equal to or greater than the threshold value, the voice output control unit 214 prevents outputting the voice data corresponding to “long speech” to the second information processing apparatus 3. The voice output control unit 214 may mute the microphone 28 in response to determining that the distance between the word of the conversion result and the related word group is equal to or greater than the threshold value.

The voice output control unit 214 outputs the voice data via the network based on the determination by the determination unit 213 that the recognition result does not satisfy the predetermined condition (ACT26). In ACT26, for example, the voice output control unit 214 outputs voice data to the second information processing apparatus 3 via the network on the basis of the fact that the determination unit 213 determines that the distance between the word of the conversion result and the related word group is not equal to or greater than the threshold value. The conversion unit 212 stores the conversion result in the related word group DB. The conversion unit 212 may update the related word group DB in real time on the basis that the determining unit 213 determines that the recognition result does not satisfy the predetermined condition. The first information processing apparatus 2 used in the web conferencing system 100 according to an embodiment can acquire voice data based on an input via the input device, perform voice recognition on the voice data, determine whether the recognition result satisfies a predetermined condition, and prevent the output of the voice data via the network based on the determination result. Therefore, the first information processing apparatus 2 can perform control so that the voice data satisfying the predetermined condition is not output to another information processing apparatus. For example, when the voice data satisfying the predetermined condition includes a word that is not desired to be transmitted to another participant or a word that is inappropriate for the conference, it is possible to prevent such a word from being output to another information processing apparatus or heard by the other participant. Thus, the first information processing apparatus 2 can prevent a specific word spoken by the user of the first information processing apparatus 2 from being transmitted, and can provide a technique capable of realizing a secure and smooth electronic conference.

The first information processing apparatus 2 can determine whether the recognition result satisfies the predetermined condition based on whether a particular keyword is included in the recognition result. Therefore, when a word uttered by the user of the first information processing apparatus 2 is one of the keywords set at the start of the conference, the first information processing apparatus 2 can perform control so that the voice data corresponding to the word is not output to the other information processing apparatus. For example, when the keyword is a word that is not desired to be transmitted to another participant or a word that is inappropriate for the conference, it is possible to prevent such a word from being output to another information processing apparatus. Thus, the first information processing apparatus 2 can prevent the keywords included in the words uttered by the user of the first information processing apparatus 2 from being transmitted, and can provide a technique capable of realizing a secure and smooth electronic conference.

The first information processing apparatus 2 can vectorize the recognition result (i.e., a recognized word) and determine whether the vectorized word satisfies a predetermined condition, i.e., whether the distance between the recognized and vectorized word and the predetermined word group is equal to or greater than a threshold value. Furthermore, the first information processing apparatus 2 can update the predetermined word group in real time. Therefore, the first information processing apparatus 2 can perform control such that the voice data corresponding to the word is not output to another information processing apparatus when the word spoken by the user of the first information processing apparatus 2 and vectorized is far from the related word group in the vector space, and can update the related word group in real time during the conference. For example, a word that is distant from a group of related words may be a word that is unrelated to a conference, a word that is inappropriate for a conference, or a word that is not desired to be transmitted to another participant. Therefore, the first information processing apparatus 2 can prevent such a word from being output to another information processing apparatus. Further, the first information processing apparatus 2 can determine whether the recognition result satisfies a predetermined condition based on the related word group updated in real time. Therefore, it is possible to dynamically change frequently used words during a conference. Thus, the first information processing apparatus 2 can dynamically determine a word or the like included in a word spoken by the user of the first information processing apparatus 2 and not related to a conference, and can prevent a word or the like not related to the conference from being transmitted in accordance with the progress of the conference, and can provide a technique capable of realizing a smoother electronic conference.

In the above-described examples, the voice output control unit 214 controls the output of the voice data has been described, but embodiments are not limited thereto. When the voice data is input from the microphone 28 to the first information processing apparatus 2, its text data is output to and displayed by the second information processing apparatus 3 in real time, the voice output control unit 214 may control the display of the text data. In such a case, the voice output control unit 214 controls the output of the text data corresponding to the voice data via the network based on the determination result by the determination unit 213. In this example, the voice output control unit 214 functions as an output control unit for text data.

The information processing apparatus 2 or 3 may be realized by one device, or may be realized by a plurality of devices in which functions are distributed.

One or more programs executed by each of the above-described processors 11, 21, and 31 may be stored in the corresponding device in advance or copied from another device. In the latter case, the programs may be transferred via a network or may be transferred from a non-transitory computer readable storage or recording medium. The recording medium may be any form as long as it can store the programs such as a CD-ROM or a memory card and can be read by a computer.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An electronic conferencing system, comprising:
a conferencing server that stores first data including one or more first keywords; and
a plurality of user terminals connectable to each other via the server for an electronic conference and each including:
a microphone, and
a processor configured to:
acquire voice data corresponding to a speech input by a user via the microphone,
convert the voice data to text data, and
determine whether to output the voice data to another user terminal based on whether a word included in the text data matches one of the first keywords.

2. The electronic conferencing system according to claim 1, wherein the processor is configured to determine not to output the voice data to another user terminal when the word included in the text data matches one of the first keywords.

3. The electronic conferencing system according to claim 2, wherein the processor is further configured to disable the microphone after determining not to output the voice data to another user terminal.

4. The electronic conferencing system according to claim 1, wherein
each of the user terminals stores second data in which a second keyword is associated with a corresponding word vector in a predetermined vector space, and
the processor of each of the user terminals is further configured to:
calculate a word vector corresponding to the word included in the text data,
calculate a distance between the calculated word vector and the word vector of the second keyword, and
determine to output the voice data to another user terminal when the calculated distance is equal to or greater than a threshold value.

5. The electronic conferencing system according to claim 4, wherein the processor is further configured to add, to the second data, the word included in the text data in association with the calculated word vector when the calculated distance is less than the threshold value.

6. The electronic conferencing system according to claim 1, wherein
the first keywords include a plurality of groups of keywords respectively associated with different types of electronic conference, and
the processor of each of the user terminals is configured to acquire one of the groups of keywords corresponding to a type of an ongoing electronic conference.

7. The electronic conferencing system according to claim 1, wherein
each of the user terminals further includes a display, and
the processor of each of the user terminals is configured to determine whether to output the text data for the display of another user terminal based on whether the word included in the text data matches one of the first keywords.

8. The electronic conferencing system according to claim 7, wherein the processor is configured to determine not to output the voice data for the display when the word included in the text data matches one of the first keywords.

9. A method for managing an electronic conference, comprising:
storing in a conferencing server first data including one or more first keywords;
connecting a plurality of user terminals via the server for an electronic conference;
acquiring, via a microphone of one of the user terminals, voice data corresponding to a speech input by a user;
converting the voice data to text data; and
determining whether to output the voice data from said one of the user terminals to another user terminal based on whether a word included in the text data matches one of the first keywords.

10. The method according to claim 9, wherein determining includes determining not to output the voice data to another user terminal when the word included in the text data matches one of the first keywords.

11. The method according to claim 10, further comprising:
disabling the microphone after determining not to output the voice data to another user terminal.

12. The method according to claim 9, further comprising:
storing, in said one of the user terminals, second data in which a second keyword is associated with a corresponding word vector in a predetermined vector space; and
after the voice data is converted to the text data, calculating a word vector corresponding to the word included in the text data,
calculating a distance between the calculated word vector and the word vector of the second keyword, and
determining to output the voice data to another user terminal when the calculated distance is equal to or greater than a threshold value.

13. The method according to claim 12, further comprising:
adding, to the second data, the word included in the text data in association with the calculated word vector when the calculated distance is less than the threshold value.

14. The method according to claim 9, wherein
the first keywords include a plurality of groups of keywords respectively associated with different types of electronic conference, and the method further comprising:
acquiring one of the groups of keywords corresponding to a type of an ongoing electronic conference.

15. The method according to claim 9, further comprising:
determining whether to output the text data for a display of said another user terminal based on whether the word included in the text data matches one of the first keywords.

16. The method according to claim 15, wherein determining further includes determining not to output the voice data for the display when the word included in the text data matches one of the first keywords.

17. A non-transitory computer readable medium storing a program for managing an electronic conference, wherein the program executed on a computer causes the computer to execute a method comprising:
acquiring first data including one or more first keywords from a conferencing server;
connecting to another user terminal via the server for an electronic conference;
acquiring voice data corresponding to a speech input by a user via a microphone;
converting the voice data to text data; and
determining whether to output the voice data to said another user terminal based on whether a word included in the text data matches one of the first keywords.

18. The computer readable medium according to claim 17, wherein determining includes determining not to output the voice data to said another user terminal when the word included in the text data matches one of the first keywords.

19. The computer readable medium according to claim 18, wherein the method further comprises disabling the microphone after determining not to output the voice data to another user terminal.

20. The computer readable medium according to claim 17, wherein the method further comprises:
storing second data in which a second keyword is associated with a corresponding word vector in a predetermined vector space; and
after the voice data is converted to the text data,
calculating a word vector corresponding to the word included in the text data,
calculating a distance between the calculated word vector and the word vector of the second keyword, and
determining whether to output the voice data to said another user terminal based on whether the calculated distance is equal to or greater than a threshold value.
